(19) United States
(12) Patent Application Publication
(10) Pub. No.: US 2021/0208450 A1
(43) Pub. Date: Jul. 8, 2021

(54) PRIVACY FILMS FOR ELECTRONIC DISPLAYS

(71) Applicant: Hewlett-Packard Development Company, L.P., Spring, TX (US)

(72) Inventors: Kuan-Ting Wu, Taipei City (TW); Hsing-Hung Hsieh, Taipei City (TW); Super Liao, Taipei City (TW)

(73) Assignee: Hewlett-Packard Development Company, L.P., Spring, TX (US)

(21) Appl. No.: 17/043,007

(22) PCT Filed: Sep. 18, 2018
(86) PCT No.: PCT/US2018/051402

§ 371 Date: Sep. 29, 2020

(51) Int. Cl. G02F 1/1335; G02F 1/1334; G02F 1/1343

(52) U.S. Cl. CPC G02F 1/133504; G02F 1/13439; G02F 1/1334

(57) ABSTRACT

The present disclosure is drawn to privacy films for electronic displays. In one example, a privacy film for an electronic display can include a first transparent electrode layer, a second transparent electrode layer, and a light-directing layer positioned between the first transparent electrode layer and the second transparent electrode layer. The light-directing layer can include multiple light-blocking barriers spaced apart across the light-directing layer as well as polymer-dispersed liquid crystal occupying spaces between the multiple light-blocking barriers.

### BACKGROUND

The use of personal electronic devices, computing devices, or any other type of device that uses an optical display continues to increase. Televisions, desktop computers, laptops, tablets, smartphones, and the like, with optical display screens have become more and more common. Portable laptop computers continue to be used by many for personal, entertainment, and business purposes. Mobile devices, including laptops, tablets, and smartphones are often used to access and view sensitive information. This information can include personal information, passwords, banking information, confidential business documents, and so on. As these types of information continue to be accessed and viewed using mobile devices, sometimes in public settings, privacy can often be a concern.

### BRIEF DESCRIPTION OF THE DRAWING

Features of the present disclosure are illustrated by way of example and not limited in the following figures, in which like numerals indicate like elements, and in which:

FIG. 1 is a schematic cross-sectional view illustrating an example privacy film in accordance with examples of the present disclosure;

FIGS. 2A-2B are schematic cross-sectional views illustrating another example privacy film in accordance with examples of the present disclosure;

FIG. 3 is a schematic cross-sectional view illustrating yet another example privacy film in accordance with examples of the present disclosure;

FIG. 4 is a schematic cross-sectional view illustrating an example electronic display in accordance with examples of the present disclosure; and

FIG. 5 is a flowchart illustrating an example method of making a privacy film for an electronic display in accordance with examples of the present disclosure.

### DETAILED DESCRIPTION

The present disclosure describes privacy films for electronic displays. In one example, a privacy film for an electronic display can include a first transparent electrode layer and a second transparent electrode layer. A light-directing layer can be positioned between the first transparent electrode layer and the second transparent electrode layer. The light-directing layer can include multiple light-blocking barriers spaced apart across the light-directing layer as well as polymer-dispersed liquid crystal occupying spaces between the multiple light-blocking barriers. In a particular example, the light-blocking barriers can be oriented along a viewing direction. In a further example, the light-blocking barriers can be oriented parallel one to another. In a different example, the light-blocking barriers can be oriented convergently to direct light converging on a viewer. In further examples, the light-blocking barriers can include a photoresist material. In still further examples, the light-blocking barriers can have a width of about 3 μm to about 30 μm, a depth of about 150 μm to about 200 μm, and a spacing width of about 250 μm to about 300 μm.

The present disclosure also extends to electronic display panels. In one example, an electronic display panel can include a privacy film, a liquid crystal display panel on a first side of the privacy film, and a backlight panel on a second side of the privacy film opposite the first side. The privacy film can include a first transparent electrode layer and a second transparent electrode layer. A light-directing layer can be positioned between the first transparent electrode layer and the second transparent electrode layer. The light-directing layer can include multiple light-blocking barriers spaced apart across the light-directing layer as well as polymer dispersed liquid crystal occupying spaces between the multiple light-blocking barriers. In some examples, the backlight panel can include a light guide film adjacent to the privacy film and an edge light positioned at an edge of the light guide film. In further examples, the electronic display panel can include a switch electrically connected to the first and second transparent electrode layers to apply an electric field to the light-directing layer to switch the light-directing layer to privacy mode. In certain examples, the light-blocking barriers can be oriented parallel one to another. In other examples, the light-blocking barriers can be oriented convergently to direct light converging on a viewer. In still further examples, the light-blocking barriers can have a width of about 3 μm to about 30 μm, a depth of about 150 μm to about 200 μm, and a spacing width of about 250 μm to about 300 μm.

The present disclosure also extends to methods of making privacy films for electronic displays. In one example, a method of making a privacy film for an electronic display can include positioning multiple light-blocking barriers spaced apart across a first transparent electrode layer. A polymer-dispersed liquid crystal can be introduced into spaces between the multiple light-blocking barriers. A second transparent electrode layer can be positioned over the light-blocking barriers and polymer-dispersed liquid crystal. In another example, a backlight panel can be positioned on the first transparent electrode layer opposite from the light-blocking barriers and polymer-dispersed liquid crystal, and a liquid crystal display panel can be positioned on the second transparent electrode layer opposite from the light-blocking barriers and polymer-dispersed liquid crystal. In yet another example, the light barriers can include a photoresist material.

In the present disclosure, it is noted that when discussing the privacy films, electronic displays, and methods described herein, discussions can be considered applicable to these examples, whether or not they are explicitly discussed in the context of that example. Thus, for example, in discussing details about the privacy films, such discussion also refers to the methods, and vice versa.

### Privacy Films for Electronic Displays

The privacy films described herein can provide a built-in switchable privacy mechanism to protect sensitive information on an electronic display. The privacy films can utilize polymer-dispersed liquid crystal to switch between a privacy mode and a sharing mode. As used herein, “privacy mode” refers to a state of the privacy film in which the viewable angle of the electronic display is restricted to a particular angle. In contrast, “sharing mode” refers to another state of the privacy film in which the viewable angle is greater than the restricted viewing angle in privacy mode.

In some examples, the privacy films described herein can be placed between the backlight unit and the liquid crystal display panel of an electronic display. Accordingly, the privacy films can be integrated as a part of the electronic display. In certain existing privacy technologies, integrated privacy mechanisms can include a louver film and a polymer-dispersed liquid crystal (PDLC) layer over the louver film. The louver film can be designed to limit the viewable angle of light passing through the louver film, and the liquid crystal layer can be designed to either allow the light to pass through at the same limited viewable angle (privacy mode) or to scatter the light at many angles (sharing mode), However, the privacy films described herein can include a single layer that can both limit the viewable angle and switch back and forth from privacy mode to sharing mode. Accordingly, the privacy films described herein can be simpler and cheaper than other technologies that include two separate films. The display can also be brighter at lower power consumption because the display can have fewer layers through which to transmit light. The display can weigh less, which can be helpful in mobile devices like laptops, smartphones, and tablet computers. Furthermore, the electronic display can have a better contrast ratio when using the privacy film described herein instead of two separate layers for the louver and the PDLC layer.

The privacy films provided herein can include light-blocking barriers oriented to direct light in a particular direction so that light travelling between the light-blocking barriers is restricted to a narrow viewable angle. The privacy films can also include polymer-dispersed liquid crystals, which can change from a light-scattering state to a transparent state with the application of an electric field. When the PDLC is in a light-scattering state, light from behind the privacy film can be scattered in all different directions to provide a wide viewable angle. When an electric field is applied to the PDLC, the liquid crystals align to make the film transparent. Thus the privacy film can be switched from sharing mode to privacy mode by applying an electric voltage across the privacy film.

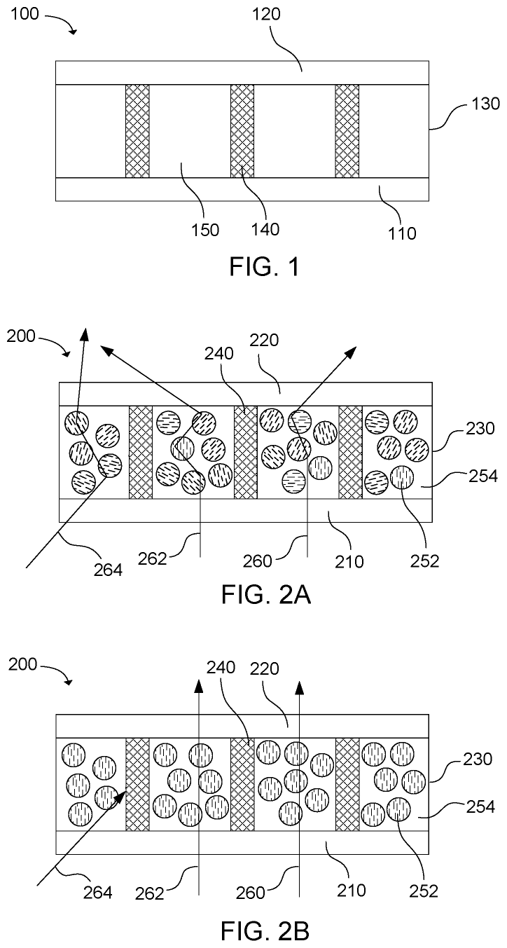

With this description in mind, FIG. 1 shows an example privacy film 100 for an electronic display. The privacy film includes a first transparent electrode layer 110, a second transparent electrode layer 120, and a light-directing layer 130 positioned between the first transparent electrode layer and the second transparent electrode layer. The light directing layer includes multiple light-blocking barriers 140 spaced apart across the light-directing layer. A PDLC 150 occupies the spaces between the multiple light-blocking barriers. This figure is not drawn to scale. Real-world examples of the privacy film can include many hundreds or thousands of light-blocking barriers instead of three light-blocking barriers as shown in FIG. 1. Additionally, the privacy film can typically be a thin film with a total thickness less than about 1 mm and a length and width the size of an electronic display, such as a laptop monitor or smartphone screen.

The PDLC layer can be switched from a scattering state to a transmitting state by applying an electric voltage to the PDLC layer. FIGS. 2A and 2B illustrate an example privacy film 200 switching between these states. FIG. 2A shows the privacy film, which includes a first transparent electrode layer 210, a second transparent electrode layer 220, and light directing layer 230 between the electrode layers. The light directing layer includes multiple light-blocking barriers 240 spaced apart with a PDLC material occupying the space between the light-blocking barriers. The PDLC material includes droplets of liquid crystal 252 dispersed in a solid polymer matrix 254. In FIG. 2A, the liquid crystal droplets are randomly aligned. The randomly aligned liquid crystal droplets scatter light in random directions. Thus, when light rays 260, 262, and 264 travel through the PDLC, the light rays are scattered at varying angles when the light rays exit from the film. When the privacy film is used in an electronic display, this scattering mode gives the electronic display a wide viewable angle. Thus, this mode can also be referred to as “sharing mode.”

FIG. 2B shows the example privacy film 200 in privacy mode. In this mode, the liquid crystal droplets 252 are aligned in one direction. Specifically, the liquid crystal droplets are aligned in the direction from a rear side of the privacy film to a viewer side of the privacy film. When the liquid crystal droplets are aligned in this way, the PDLC becomes transparent instead of scattering. Therefore, the light rays 260, 262 travel through the PDLC material without being scattered in other directions. The light-blocking barriers 240 are parallel extending from the first transparent electrode layer 210 to the second transparent electrode layer 220. Light rays that travel straight through the film (i.e., having a 90° angle with respect to the surface of the film) are transmitted all the way through the PDLC portions and eventually these light rays can be seen by a viewer. Light rays that have an angle close to 90° with respect to the surface of the film can also pass through the PDLC. However, light rays that diverge too far from 90°, such as light ray 264, can be blocked by the light-blocking barriers. Accordingly, in this mode the privacy film can restrict the viewable angle of light passing through the privacy film.

In some examples, the light-blocking barriers can be parallel as shown in FIGS. 2A-2B. When such a privacy film is used in an electronic display, the display can be visible to a viewer positioned directly in front of the electronic display or within a certain distance off-center. The viewable angle can be restricted so that onlookers outside the viewable angle cannot see information displayed on the screen. However, with such a privacy film there can be a risk that onlookers positioned behind the viewer can also see the information on the display. Accordingly, in some examples the light-blocking barriers can be oriented convergently to direct light converging on the viewer. The privacy film can be designed to direct light from the display to converge on the viewer at a particular distance away from the display. Onlookers positioned at a further distance behind the viewer would then not be able to see the information on the display because the onlookers are too distant from the display.

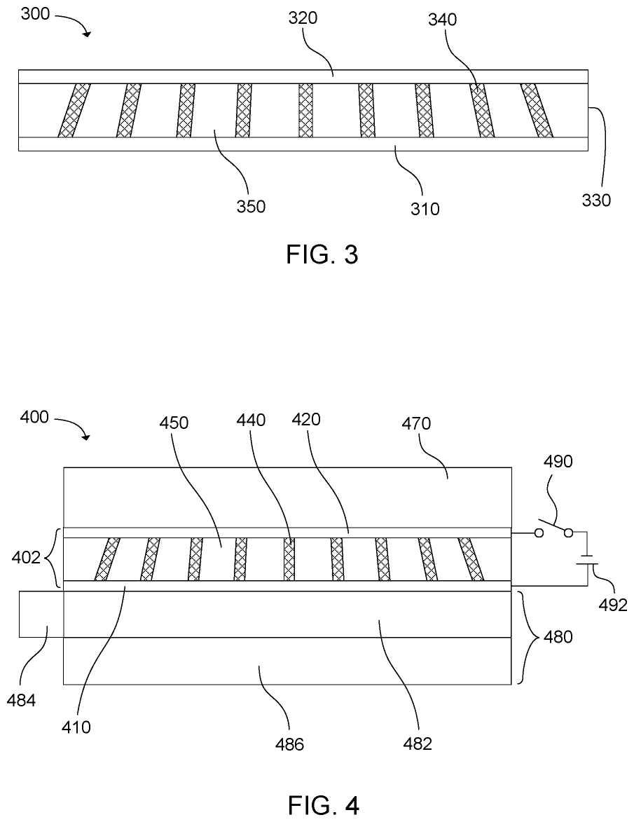

FIG. 3 shows another example privacy film 300 including a first transparent electrode layer 310, a second transparent electrode layer 320, and a light directing layer 330. The light directing layer includes light-blocking barriers 340 that are angled toward the center of the film in such a way that the light-blocking barriers direct light to converge on a viewer at a certain distance from the privacy film. A PDLC material 350 occupies spaces between the light-blocking barriers. Because the light passing through this privacy film converges on a viewer at a particular distance from the privacy film, onlookers at a further distance will not be able to see the entire display. Additionally, this type of privacy film can restrict the viewable angle to a narrower angle than privacy films that have parallel light-blocking barriers.

### Electronic Display Panels

The present disclosure also extends to electronic display panels that incorporate privacy films. FIG. 4 shows one example electronic display panel 400 that includes a privacy film 402. The privacy film includes a first transparent electrode layer 410, a second transparent electrode layer 420, convergently-oriented light-blocking barriers 440, and a PDLC material 450 in spaces between the light-blocking barriers. The electronic display panel also includes a liquid crystal display panel 470 on a first side of the privacy film and a backlight panel 480 on a second side of the privacy film opposite the first side. In this example, the backlight panel includes a light guide film 482 adjacent to the privacy film and an edge light 484 positioned at an edge of the light guide film. Also, a reflector 486 is behind the light guide film. The electronic display panel also includes a switch 490 and a power supply 492 electrically connected to the first and second transparent electrode layers to apply an electric field to the PDLC to switch the privacy film to privacy mode.

The example electronic display panel shown in FIG. 4 includes an edge-lit light guide film to provide light for the display. In some cases, the edge light can be a light emitting diode (LED) or a strip of multiple LEDs. In certain examples, a series of LEDs can be positioned along one edge of the backlight panel. In other examples, LEDs can be positioned along more than one edge of the backlight panel, such as around all the edges of the backlight panel. The light guide film can be a sheet of transparent material such as plastic with many small optical features that diffuse light from the edge lights and redirect the light forward to the front of the display. In the example shown in FIG. 4, a reflector is placed behind the light guide film to reflect any backwards-shining light back to the front of the display.

In further examples, other types of backlights can also be used. In certain examples, the backlight panel can be a direct-lit LED panel with an array of LEDs positioned across the area of the backlight panel. A diffuser film can be placed in front of the LEDs to provide diffuse light. Other types of backlights can also be used, such as electroluminescent panels, fluorescent lamps, and others.

In some examples, a liquid crystal display panel can be positioned over the privacy film. That is, the liquid crystal display panel can be between the privacy film and the viewer. Any type of liquid crystal display panel can be used, such as twisted nematic (TN), in-plane switching (IPS), and others.

### Light-Blocking Barriers

As mentioned above, the light-blocking barriers can be arranged to direct light at a narrow viewable angle. In some examples, the light-blocking barriers can be parallel to direct light straight forward from the electronic display. In other examples, the light-blocking barriers can be oriented convergently to direct light converging on a viewer at a particular distance from the electronic display. The privacy film can often include many light-blocking barriers (i.e., hundreds or thousands) and the light-blocking barriers can be quite small. In some examples, the light-blocking barriers can have a width from about 3 μm to about 30 μm, from about 5 μm to about 25 μm, or from about 8 μm to about 20 μm. In further examples, the light-blocking barriers can have a depth (i.e., from the back surface of the privacy film to the front surface) from about 50 μm to about 500 μm, from about 100 μm to about 300 μm, or from about 150 μm to about 200 μm. The light-blocking barriers can be spaced apart with a spacing distance from about 100 μm to about 500 μm, from about 200 μm to about 400 μm, or from about 250 μm to about 300 μm.

Although the light-blocking barriers can be formed by any suitable method, in some examples it can be convenient to form the light-blocking barriers through photolithography. As mentioned above, the light-blocking barriers can be formed of a photoresist material or a photoresist material can be used to make a mask to form the light-blocking barriers by etching.

In some examples, the light-blocking barriers can include a positive photoresist or a negative photoresist. Positive photoresists refer to materials that are weakened by light. The portions of the positive photoresist that are exposed to light can be easily removed by dissolving in a developing solution, while the unexposed portions remain. Accordingly, to form light-blocking barriers from a positive photoresist, a layer of photoresist can be applied and then exposed to light using a mask that forms shadows where the light-blocking barriers are to be located. The portions of the photoresist layer between the light-blocking barriers can be weakened by the light. In some cases, the light can cause scission or breakage of molecular chains in the photoresist polymer. The weakened portions can then be removed by dissolving in a developing solution to leave the light-blocking barriers. Non-limiting examples of positive photoresists that can be used include poly methylmethacrylate (PMMA), two-component diazoquinone ester and phenolic novolak resin (DNQ), diazonaphthoquinone and novolak resin, and others. Specific examples of positive photoresists can include positive photoresists from the AZ® series of photoresists available from Merck Performance Materials GmbH (Germany).

Negative photoresists are materials that are strengthened or cured by exposure to light. The negative photoresist can be applied as a layer, either as a liquid solution or a solid material layer. The portions of the negative photoresist that are to become light-blocking barriers can be exposed to light while the remainder of the negative photoresist can be masked to prevent light exposure. Unexposed portions can then be removed by dissolving in a developer solution. Non-limiting examples of negative photoresists can include epoxy-based ultraviolet (UV) curing polymers and off-stoichiometry thiol-ene (OSTE) polymers. Specific examples of negative photoresists can include the SU-8 series of negative photoresists available from Microchem (Massachusetts), and negative photoresists from the AZ® series and AZ® nLof series of photoresists available from Merck Performance Materials GmbH (Germany).

Photoresist materials can be applied directly to one of the transparent electrode layers or to another transparent substrate. Although the transparent electrode layers are shown in direct contact with the light-blocking barriers in many examples discussed herein, in some cases the light directing layer can include additional layers such as transparent substrate layers in contact with the transparent electrode layers. Such additional layers can include glass, polyethylene terephthalate (PET), polyethylene (PE), polyimide (PI), polycarbonate (PC), poly(methyl methacrylate) (PMMA), or others materials. Photoresist materials can be applied by several methods, such as spin coating, spray coating, dip coating, slot coating, applying a solid material layer, and others.

The photoresist can be exposed to light that is sufficient to cure the photoresist (for negative photoresists) or weaken the photoresist (for positive photoresists) using a mask shaped to form the light-blocking barriers. In some examples, the light source for exposing the photoresist can be a UV light source. In certain examples, the light source can be a UV lamp, a collimated UV lamp, a UV laser, or others. In alternative examples, an electron beam can be used to expose the photoresist.

In some examples, a mask for forming the light-blocking barriers can include a plurality of slits having the desired width of the light-blocking barriers and spaced apart at the desired spacing width between the light-blocking barriers. This type of mask can be used with a negative photoresist to form the light-blocking barriers. In certain examples, this can result in parallel light-blocking barriers that direct light straight forward from the electronic display. In other examples, light-blocking barriers that are oriented convergently can be made by altering the angle of the light exposing the photoresist. Tilt-light exposure can be used in some examples. For example, the photoresist and substrate can be tilted while the light source remains stationary. The angle of tilt of the substrate can be changed slightly for individual light-blocking barriers so that the light-blocking barriers are angled to direct light converging on a viewer. In other examples, the light-blocking barriers can be formed in groups, with the various groups of multiple light-blocking barriers having the same angle. The angles of the groups can be designed to direct light converging on a viewer. In certain examples, the light-blocking barriers can be made one at a time. This can be accomplished, for example, by using a laser or electron beam to expose a single light-blocking barrier at a time or by using a mask that allows light to expose one light-blocking barrier at a time. In another example, the convergently angled light-blocking barriers can all be formed simultaneously by using a mask and point light source positioned at the same location that a viewer would be positioned with respect to the privacy film. The light from the point light source can naturally expose the photoresist at an appropriate angle to form convergently angled light-blocking barriers.

In various examples, the light-blocking barriers can extend from a top of the privacy film to a bottom of the privacy film as viewed by a viewer. Thus, the light-blocking barriers can restrict the side-to-side viewable angle but may not affect the top-to-bottom viewable angle.

In further examples, the light-blocking barriers can be formed of a photoresist material that is opaque to block light. In certain examples, the photoresist can be colored black. In some cases a black pigment or black dye can be dispersed in the photoresist. Examples of black pigments can include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® L, MONARCH® 700, MONARCH® 800, MONARCH® 880, MONARCH® 900, MONARCH® 1000, MONARCH® 1100, MONARCH® 1300, and MONARCH® 1400); and various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). A non-limiting example of an organic black pigment includes aniline black, such as C.I. Pigment Black 1. In certain examples, the pigment particles can have an average particle size from about 1 nm to about 5 μm.

### Polymer-Dispersed Liquid Crystal

The PDLC in the light directing layer of the privacy film can include droplets of liquid crystal dispersed in a solid polymer matrix. In some examples, the PDLC can be made by forming a liquid mixture of a liquid crystal material and a liquid curable polymer material. In certain examples, the liquid crystal can be mixed with a curable polymer such as a polyacrylate, polythiolene, epoxy, or others. When the polymer is cured, the liquid crystal can form droplets trapped in the solid matrix of cured adhesive. The droplets can have a size on the micrometer scale. In various examples, the amount of the polymer matrix can range from about 20 wt % to about 80 wt % by total weight of the PDLC material. In further examples, the amount of the polymer matrix can range from about 30 wt % to about 50 wt % by total weight of the PDLC material.

The liquid crystal droplets can include any liquid crystal compound that can become aligned when an electric field is applied and non-aligned when the electric field is removed. The aligned state can be referred to as a “nematic” phase of the liquid crystal. Non-limiting examples of liquid crystal compounds can include cyanobiphenyls, fluorinated biphenyls, carbonates, phenyl esters, Schiff bases, azoxybenzenes, cholesteryl compounds, poly(polyethyleneglycol methacrylate), and analogs thereof.

As mentioned above, the PDLC can fill the space between the light-blocking barriers. In some examples, the PDLC material can be applied in liquid form to the privacy film after forming the light-blocking barriers. In a particular example, the light-blocking barriers can be formed on a substrate such as a transparent electrode layer or another transparent substrate. The PDLC material in liquid form can then be coated on the substrate at the same thickness as the depth of the light-blocking barriers. Then PDLC material can be cured to form the solid polymer matrix with dispersed liquid crystal droplets. The privacy film can then be completed by adding a second transparent electrode layer or other transparent substrate over the top of the PDLC and light-blocking barriers.

In some examples, the polymer-dispersed liquid crystal can scatter light strongly when the liquid crystal droplets are not aligned. This can result in a wide viewable angle, such as up to about 180°, because light is emitted from the privacy film at all angles. When the liquid crystal droplets are aligned, the PDLC can be transparent or partially transparent. When the PDLC is completely transparent or substantially transparent (i.e., no light scattering or negligible light scattering) then the viewable angle can be restricted by the light-blocking barriers. The viewable angle can be adjusted by changing the depth of the light-blocking barriers, width of the light-blocking barriers, spacing between the light-blocking barriers, and orientation of the light-blocking barriers. In some examples, using convergently angled light-blocking barriers can result in a more restricted viewable angle and increased privacy for the viewer. In further examples, if the PDLC still scatters some light when the liquid crystal droplets are aligned then the scattering can result in a wider viewable angle. Accordingly, the transparency of the PDLC can also affect the viewable angle of the electronic display. In some examples, the viewable angle of the privacy film in privacy mode can be from about 20° to about 80° or from about 30° to about 60°. As used herein, “viewable angle” can refer to an angle centered on a viewer sitting directly in front of the privacy film. As such, the line of sight of the viewer can be perpendicular to the surface of the privacy film when the viewer is located directly in front of the privacy film, and if the viewer moves far enough to the left or right then the viewer can eventually move outside the viewable angle in privacy mode. For example, if the viewable angle is 20° then the viewer can move outside the viewable angle if the viewer moves more than 10° to the left or right, because the 20° viewable angle is centered on the viewer when the viewer is directly in front of the privacy film. In sharing mode, the viewable angle can be up to 180°, which would allow the viewer to see the electronic display from any possible angle as long as the viewer is not behind the electronic display.

### Transparent Electrode Layers

The transparent electrode layers can be positioned on a viewer side and a rear side of the PDLC. In many of the examples described herein, the first and second transparent electrode layers are positioned in direct contact with the PDLC and the light-blocking barriers. However, in some examples the transparent electrode layers can be separated from the PDLC by intervening layers, such as layers of transparent substrates. A voltage can be applied to the transparent electrode layers to form an electric field of sufficient strength to align the liquid crystals in the PDLC portions of the privacy film.

Non-limiting examples of suitable materials for the transparent electrode layers include a metal (such as, e.g., gold, aluminum, nickel, copper, etc.), a conductive oxide (such as, e.g., indium tin oxide, etc.), a conductive polymer (such as, e.g., PEDOT (poly(3,4-ethylenedioxythiophene), and/or the like), silver nanowire, a conductive composite (such as, e.g., a layer of carbon nano-tubes, etc.), and/or combinations thereof.

### Methods of Making Privacy Films for Electronic Displays

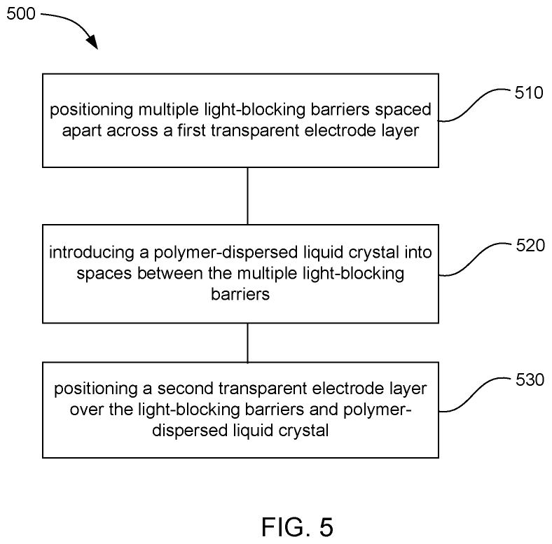

The present disclosure also extends to methods of making privacy films for electronic displays. FIG. 5 is a flowchart illustrating one example method 500 of making a privacy film for an electronic display. The method includes positioning 510 multiple light-blocking barriers spaced apart across a first transparent electrode layer; introducing 520 a polymer-dispersed liquid crystal into spaces between the multiple light-blocking barriers; and positioning 530 a second transparent electrode layer over the light-blocking barriers and polymer-dispersed liquid crystal. In further examples, methods can also include positioning a backlight panel on the first transparent electrode layer opposite from the light-blocking barriers and polymer-dispersed liquid crystal. A liquid crystal display panel can also be positioned on the second transparent electrode layer opposite from the light-blocking barriers and polymer-dispersed liquid crystal. In this way, an electronic display can be assembled.

In some examples, the light-blocking barriers can be made using a photoresist material as described above. In certain examples, the light-blocking barriers can be formed of a photoresist material itself. In other examples, a photoresist can be used to make an etching mask and the light-blocking barriers can be etched from a different material. The light-blocking barriers and other components of the privacy film can be made using any of the materials and processes described above.

### Definitions

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and can be determined based on experience and the associated description herein.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the Mastersizer™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, a plurality of items, structural elements, compositional elements, and/or materials may be presented in a common list for convenience. However, these lists should be construed as though members of the list are individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if individual numerical value and sub-range is explicitly recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### EXAMPLE

In one example, a privacy film is made by forming a transparent electrode layer. The transparent electrode layer is a layer of PEDOT about 10 microns thick. Light-blocking barriers are formed on top of the transparent electrode layer. The light-blocking barriers are made by applying SU-8 photoresist with a black pigment dispersed in the photoresist on the transparent electrode layer, and then exposing the photoresist to UV light using a mask that allows light to expose the portions of the photoresist that are to become light-blocking barriers. The light-blocking barriers in this example are parallel slats having a width of 10 μm, a depth of 150 μm, and a spacing width of 250 μm. After forming the light-blocking barriers and removing excess photoresist material using a developing solution, an uncured PDLC is coated on the transparent electrode layer to fill the spaces between the light-blocking barriers. The PDLC includes 4-cyano-4′-pentylbiphenyl as the liquid crystal material and a UV curable polyacrylate polymer. The PDLC is then cured by exposure to UV light. A second layer of PEDOT is then placed over the PDLC and light-blocking barriers to act as a second electrode.

The privacy film is integrated into an electronic display by placing the privacy film between the backlight unit and the liquid crystal display panel. The two PEDOT layers are electrically connected to a switch and a power supply. When a voltage is applied to the privacy film, the PDLC becomes transparent and the light-blocking barriers restrict the viewable angle of the electronic display to a narrow angle. When the voltage is turned off, the PDLC becomes cloudy and scatters the light from the backlight, which results in a wide viewable angle for the electronic display.

What has been described and illustrated herein are examples related to the disclosure along with some of its variations. The terms, descriptions, and figures used herein are set forth by way of illustration and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A privacy film for an electronic display comprising:
a first transparent electrode layer;
a second transparent electrode layer; and
a light-directing layer positioned between the first transparent electrode layer and the second transparent electrode layer, wherein the light-directing layer comprises multiple light-blocking barriers spaced apart across the light-directing layer as well as polymer-dispersed liquid crystal occupying spaces between the multiple light-blocking barriers.

2. The privacy film of claim 1, wherein the light-blocking barriers are oriented along a viewing direction.

3. The privacy film of claim 2, wherein the light-blocking barriers are oriented parallel one to another.

4. The privacy film of claim 2, wherein the light-blocking barriers are oriented convergently to direct light converging on a viewer.

5. The privacy film of claim 1, wherein the light-blocking barriers comprise a photoresist material.

6. The privacy film of claim 1, wherein the light-blocking barriers have a width of about 3 μm to about 30 μm, a depth of about 150 μm to about 200 μm, and a spacing width of about 250 μm to about 300 μm.

7. An electronic display panel comprising:
a privacy film comprising:
a first transparent electrode layer,
a second transparent electrode layer, and
a light-directing layer positioned between the first transparent electrode layer and the second transparent electrode layer, wherein the light-directing layer comprises multiple light-blocking barriers spaced apart across the light-directing layer as well as polymer-dispersed liquid crystal occupying spaces between the multiple light-blocking-barriers;
a liquid crystal display panel on a first side of the privacy film; and
a backlight panel on a second side of the privacy film opposite the first side.

8. The electronic display panel of claim 7, wherein the backlight panel comprises a light guide film adjacent to the privacy film and an edge light positioned at an edge of the light guide film.

9. The electronic display panel of claim 7, further comprising a switch electrically connected to the first and second transparent electrode layers to apply an electric field to the light-directing layer to switch the light-directing layer to privacy mode.

10. The electronic display panel of claim 7, wherein the light-blocking barriers are oriented parallel one to another.

11. The electronic display panel of claim 7, wherein the light-blocking barriers are oriented convergently to direct light converging on a viewer.

12. The electronic display panel of claim 7, wherein the light-blocking barriers have a width of about 3 μm to about 30 μm, a depth of about 150 μm to about 200 μm, and a spacing width of about 250 μm to about 300 μm.

13. A method of making a privacy film for an electronic display comprising:
positioning multiple light-blocking barriers spaced apart across a first transparent electrode layer;
introducing a polymer-dispersed liquid crystal into spaces between the multiple light-blocking barriers; and
positioning a second transparent electrode layer over the light-blocking barriers and polymer-dispersed liquid crystal.

14. The method of claim 13, further comprising:
positioning a backlight panel on the first transparent electrode layer opposite from the light-blocking barriers and polymer-dispersed liquid crystal; and
positioning a liquid crystal display panel on the second transparent electrode layer opposite from the light-blocking barriers and polymer-dispersed liquid crystal.

15. The method of claim 13, wherein the light-blocking barriers comprise a photoresist material.
